(19) United States
(12) Patent Application Publication
(10) Pub. No.: US 2014/0368993 A1
(43) Pub. Date: Dec. 18, 2014

(54) USING SYNTHETIC SETAE ON MOBILE DEVICE HOUSING

(71) Applicant: NVIDIA Corporation, Santa Clara, CA (US)

(72) Inventors: Xiang SUN, Shenzhen (CN); Fei WANG, Guangzhou (CN); Yu ZHOU, Shenzhen (CN)

(21) Appl. No.: 13/921,125

(22) Filed: Jun. 18, 2013

(51) Int. Cl. G06F 1/16; F16B 11/00

(52) U.S. Cl. CPC G06F 1/1633; F16B 11/00
USPC 361/679.55; 403/265

(57) ABSTRACT

Mobile computing device employing a synthetic setae member array to selectively secure the mobile computing device to extrinsic opposing surfaces by intermolecular forces. The synthetic setae member array is disposed on the exterior housing of the associated mobile computing device and reusable for adhering the device to various extrinsic opposing surfaces. The adhesion forces can be engaged when a user applies a pressure on the mobile device against an opposing surface. The mobile device can be removed from the opposing surface without damaging the opposing surface when subject to a life-off force. The extrinsic surfaces include hard surfaces commonly encountered in everyday life.

### TECHNICAL FIELD

Embodiments of the present disclosure relate generally to mobile devices and, more particularly, to exterior housing designs of mobile devices.

### BACKGROUND

Mobile computing devices, such as smart phones, tablet computers, Internet/webpage viewers, electronic books, digital photo frames, electronic game consoles, PDAs, media viewers/players and the like have gained increasing popularity. The portability of the mobile devices allows users to carry them almost anywhere. Typically mobile devices are equipped with flat panel display screens that have limited viewing angles, e.g. near vertical, and thus often need to be positioned within a certain angle range in order to achieve an optimal view angle for a user.

Most of the mobile devices are designed to be handheld and lack a built-in supporting mechanism that could retain the device in an optimal view angle. Without using an external positioning mechanism, mobile devices usually can only be placed on a near horizontal surface, forcing the user to lower his or her head to view. Handholding mobile devices and/or viewing the screen with the neck bent for extended periods of time is neither ergonomic nor convenient.

A conventional solution to this problem is to use a peripheral attachment to prop a mobile device in a near vertical angle. A typical design employs a flap element mounted at the back of a protection case of the mobile device. The disadvantages accompanying this approach are multifaceted. The mobile devices together with the case can only be placed on a counter top surface. The usage is limited to circumstances where a supporting countertop surface is available. In addition, the cases add significant volume and weight for a user to carry around. Also the mobile device is usually not secured to the surface.

Although the underlying adhesive mechanisms have not been fully understood, geckos are renowned for their phenomenal capability of rapidly climbing and adhering to vertical surfaces of many different types. The gecko toes have a special adaptation that allows them to adhere to most surfaces without the use of liquids or surface tension. It is hypothesized that the numerous setae split into nanoscale spatulae at the end, making it sufficient for Van der Waals forces alone to provide the resultant adhesive strength. In addition, it has been observed that gecko setae is capable of self-cleaning and becomes cleaner with repeated use. The common contaminants, such as sand, dust, leaf litter and pollen, hardly impact the gecko setae adhesion, unlike the other adhesives.

Synthetic setae that emulates the setae found on the toes of geckos has been researched and fabricated. Similar with the gecko setae, when pressure is applied to marry the synthetic setae contact with an opposing surface, a strong attraction force can be formed between the setae and the opposing surface when the synthetic setae is subject to a compressive pressure against the opposing surface. The setae can be readily removed from the surface when subject to a separating force. The degree of bonding may be influenced by the amount of pressure which is used to apply the adhesive to the surface. Principals of gecko setae adhesion and fabrications of gecko-like setae adhesive are disclosed in U.S. patent publication No. US20030208888, by Fearing et al., and U.S. Pat. No. 7,335,271 by Autumn et al, both of which are incorporated by reference herein.

### SUMMARY OF THE INVENTION

Therefore, it would be advantageous to provide a reusable bonding mechanism that allows a user to conveniently secure a mobile device to various sturdy surfaces that are commonly encountered in everyday life, regardless of the orientation and material of the surfaces. Embodiments of the present disclosure exploit a synthetic setae array coupled to the exterior housing of a mobile computing device to bind the mobile device to various supporting surfaces temporarily once a pressure is applied thereon. The synthetic setae are characteristic of strong adhesion which can hold the mobile device against the weight of the mobile device. The mobile device can be detached from the supporting surface without damaging or leaving residue on the external surface whenever sufficient force is applied to separate the synthetic setae from the surface. Thereby, a user can easily find a receptive surface to secure the mobile device thereon, including a vertical or horizontal surface, and advantageously view the display panel in desired angles with hands free.

In one embodiment of present disclosure, a mobile computing device comprises a processor, a memory, a bus, a display panel, and an exterior housing. The exterior housing comprises a synthetic setae member array operable to selectively secure the exterior housing to an extrinsic surface by adhesive force. The exterior housing is configured to contain the processor, the memory, the bus and secure the display panel. The exterior housing may be released from the extrinsic surface when a mechanical force is applied to disengage the adhesive force. The extrinsic force may be a solid surface of an area of a door, a wall, a desk, a window, or a cardboard. The synthetic setae member array is reusable for selectively securing a plurality of types of extrinsic surfaces.

In another embodiment of present disclosure, an apparatus operable to adhesively attach a mobile computing device to various external solid surfaces comprises a fabricated setae component comprising a plurality of elongated protractions and a substrate supporting the protrusions. The protrusions are operable to adhere to the various external solid surfaces by intermolecular van der Waals forces. The apparatus further comprises a base component supporting the setae member and operable to be coupled with a housing of the mobile computing device. The apparatus may be a detachable accessory to the mobile device. The external solid surfaces may comprise a glass surface, a wall paint surface, a wooden surface, a metal surface, a tile surface, a brick surface, a concrete surface, a plastic surface, or a combination thereof.

In another embodiment of present disclosure, a mobile computing device comprises a processor, a display panel, a memory, a bus, an exterior housing, and a reusable dry adhesive member coupled to the housing. The reusable dry adhesive member is operable to adhere the housing onto various external supporting surfaces. The adhesive member comprises a plurality of fibriliar protrusions and a substrate supporting the protrusions. When engaged, the fibriliar protrusions are operable to adhere to various supporting surfaces via van der Waals forces. The mobile device may further comprises control circuitry coupled to the adhesive member, and a GUI configured to instruct the control circuit to selectively activate or deactivate the reusable dry adhesive member in response to a user request. The exterior housing may comprise a slide cover operable to cover adhesive member to isolate it from various external supporting surfaces.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 illustrates an exemplary configuration of a mobile computing device having a synthetic setae member on the exterior housing in accordance with an embodiment of the present disclosure.

FIG. 2 illustrates a user viewing a display panel of a mobile computing device adhering to a vertical surface through a synthetic setae array in accordance with an embodiment of the present disclosure.

FIG. 3A illustrates the microstructure of a spatula of synthetic setae made of polystyrene that can be used in conjunction with a mobile computing device in accordance with an embodiment of the present disclosure.

FIG. 3B illustrates the microstructure of a synthetic setae made of parylene that can be used in conjunction with a mobile computing device in accordance with an embodiment of the present disclosure.

FIG. 3C illustrates the microstructure of a synthetic setae made of carbon nanotubes (CNT) that can be used in conjunction with a mobile computing device in accordance with an embodiment of the present disclosure.

FIG. 4 illustrates the front side of a mobile computing device equipped with control logic controlling the adhesion capability of a synthetic setae member in accordance with an embodiment of the present disclosure.

FIG. 5 illustrates a back side of a mobile computing device equipped with a sliding cover for a synthetic setae member in accordance with an embodiment of the present disclosure

FIG. 6 is a block diagram illustrating an exemplary configuration of a mobile computing device employing synthetic setae as reusable adhesive in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Using Synthetic Setae on Mobile Device Housing

As used therein synthetic setae may include a dry adhesive material comprising nanoscale hairs extending from a substrate capable of conforming to and adhering to an opposing surface.

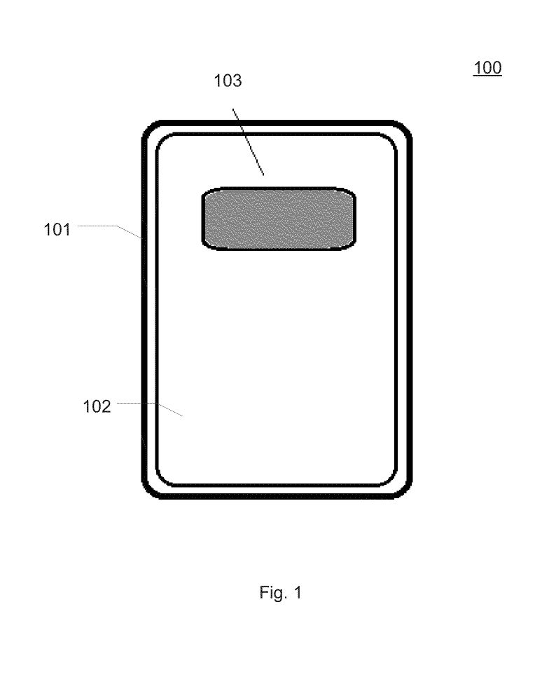

FIG. 1 illustrates an exemplary configuration of a mobile computing device 100 equipped with a synthetic setae member 103 on the exterior housing 101 in accordance with an embodiment of the present disclosure. The mobile computing device 100 has a display screen (not explicitly shown) on the front side, and the setae member 103 is mounted on the back side of the exterior housing 101. When firm pressure is applied from the front side to press the mobile device 100 against a solid surface (not shown), such as a wall, a strong and yet temporary bond is formed between the synthetic setae member 103 and the solid surface such that the mobile device 100 can be secured on the surface against its own weight. Thereby, by use of a synthetic setae member as an adhesive element, a user can secure the mobile computing device against a sturdy surface, hereby releasing his or her hand while viewing the display screen.

When a user applies a force to separate synthetic setae member 103 from the extrinsic solid surface, the synthetic setae member 103 along with the mobile computing device can be lifted off from the surface without damaging or leaving residue. The synthetic setae member 103 is reusable for securing the mobile device to a variety of different surfaces. In some embodiments, the synthetic setae member 103 is capable of self-cleaning and becomes cleaner with repeated use.

According to the illustrated example, the exemplary setae member 103 is in a square shape. However, the present disclosure is not limited by the physical attributes of the synthetic setae member or member array, including sizes, shapes, arrangement pattern, locations and quantity. For example, the mobile computing device may comprise four round shape setae members located in the corners of the device respectively. In some embodiments, the foregoing physical attributes can be configured based on the weight and shape of the mobile device during the design process.

The synthetic setae member or member array may be an integral and fixed part of the mobile device housing. The synthetic setae member may be fastened to the mobile device housing any feasible means. In some other embodiments, a synthetic setae member may be a component of a peripheral accessory, for instance a protection case, that can be attached to and detached from the mobile device at a user's will.

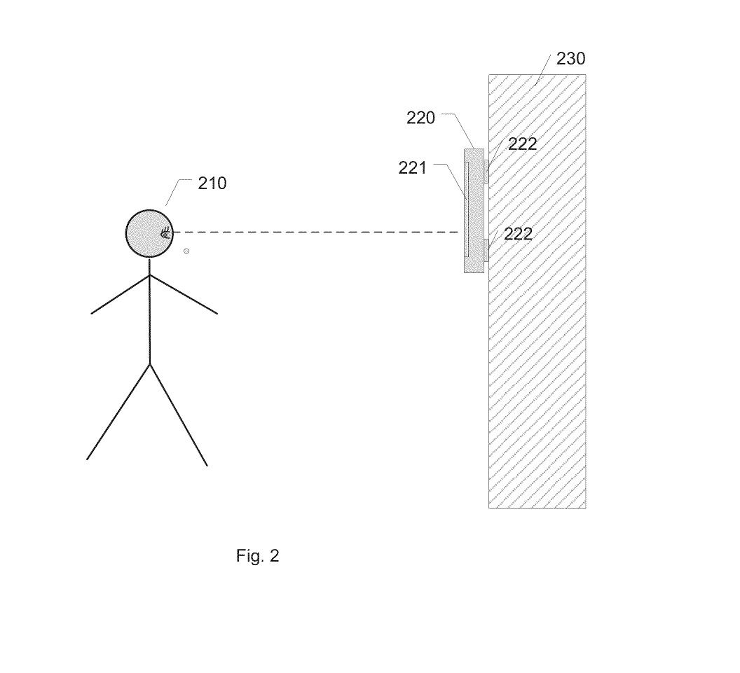

In some embodiments, a setae member associated with a mobile computing device can create adequate attraction force to hold the device against its gravity. That is, the mobile device can be hung on a vertical sturdy surface merely by virtue of the attraction forces. FIG. 2 illustrates a user 210 viewing a display panel 221 of a mobile computing device 220 adhering to a vertical surface 230 through a synthetic setae array in accordance with an embodiment of the present disclosure. As shown, the user 210 can view the content displayed on the device 220 in a desired vertical orientation without using hands or an external supporting apparatus to retain the orientation.

Synthetic setae member 103 can adhere to a variety of surfaces commonly encountered in a user's everyday life, including the surfaces of a wall, furniture, a window, cardboard, etc. The surfaces can be made of a wide range of solid material, such as glass, wall paint, wood, metal, tile, bricks, concrete, plastic, or a combination thereof. Thus, a user can easily find such a solid surface to secure the mobile device and use it hands-free in a desired orientation.

The present disclosure is not limited to any particular fabrication method, material composition and specific microstructure of the setae member or member array. For example, in some embodiments, a setae member can be made of polymers, either hydrophobic or hydrophilic, like polyimide, polystyrene, parylene, polyurethane, polydimethyl siloxane, polypropylene, and/or combinations thereof. In some other embodiments, a setae member may be made of cyclodextrins, crown ethers, polyhedral oligometric silsequioxanes, or combinations thereof. In still some other embodiments, a setae member can be made of carbon nanotubes. Fabrication may include processes by one or more of photolithography/electron beam lithography, plasma etching, deep reactive ion etching (DRIE), chemical vapor deposition (CVD), and micro-moulding, etc.

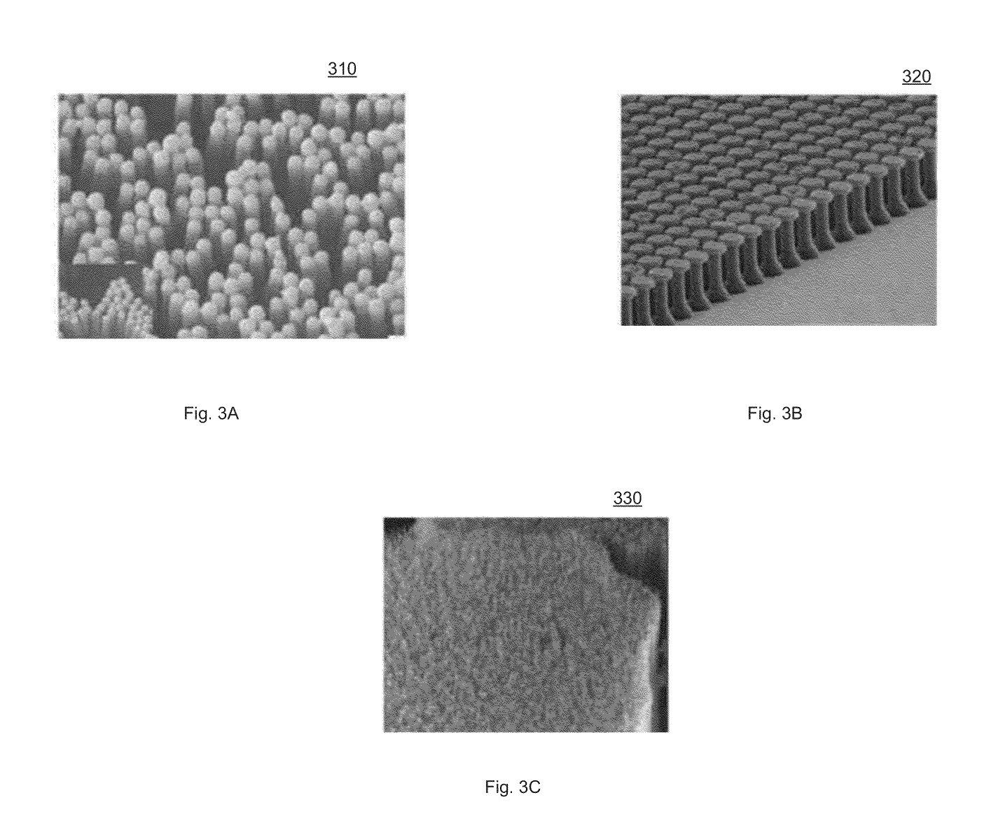

Typically synthetic setae material comprises a substrate and a plurality of adhesive hairs arising from the substrate that mimic the spatula of gecko setae. In some embodiments, each hair may provide an adhesive force between about 60 to 2000 nano-Newtons. For instance, a plurality of adhesive hairs may have a surface density of approximately 500 hairs per square millimeter. The substrate may be flexible or rigid. FIG. 3A illustrates the microstructure of a spatula of synthetic setae 310 made of polystyrene that can be used in conjunction with a mobile computing device in accordance with an embodiment of the present disclosure. FIG. 3B illustrates the microstructure of a synthetic setae 320 made of parylene that can be used in conjunction with a mobile computing device in accordance with an embodiment of the present disclosure. The hairs 322 of setae 320 arise from a substrate 321 vertically and terminate with spoon-like tips. FIG. 3C illustrates the microstructure of a synthetic setae 330 made of CNTs that can be used in conjunction with a mobile computing device in accordance with an embodiment of the present disclosure.

As shown in FIG. 3A-3C, the adhesive hairs made of different materials show wide variations in dimension, shapes, orientations, densities, etc. For example, an individual hair on synthetic setae members may have a length from 0.5 micron to 8 mm, or more specifically from 2 microns to about 500 microns, and a diameter from 0.5 micron to about 50 microns, or more specifically from 2 microns to about 10 microns. The aspect ratio of the hairs may vary from about 3 to about 1000. The hairs may space apart from each other by distances ranging from about 1 micron to about 1000 microns. The hairs may be oriented at an angle between 0° to 90° with reference to the substrate of the setae.

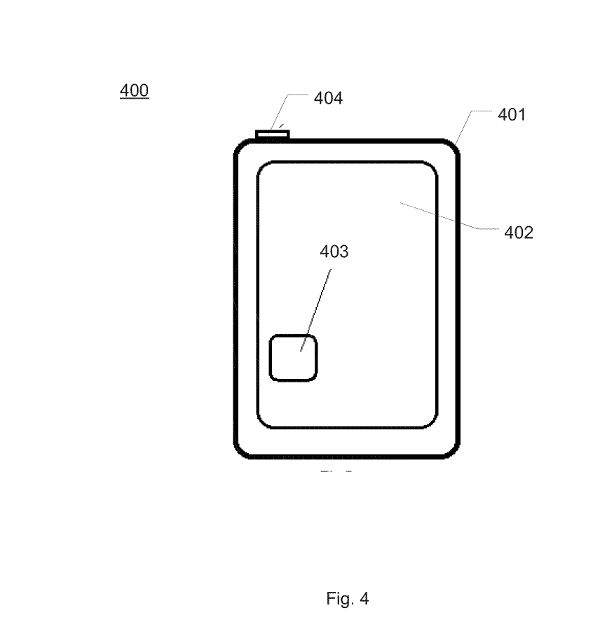

Despite the convenience afforded by synthesis setae adhesive, it may be desirable that the adhesion forces can only be engaged when a user so intends. FIG. 4 illustrate the front side of a mobile computing device 400 equipped with control logic controlling the selective adhesion capability of a synthetic setae member in accordance with an embodiment of the present disclosure. The mobile computing device 400 has a synthetic setae member (not explicitly shown) installed, e.g. on the back side of the housing and coupled to the control logic (not shown). In some embodiments, the adhesive capability of the synthetic setae member is controllable by an electronic current or a magnetic field applied thereto. In such cases, the control logic can be used to activate or deactivate the adhesive capability of the setae member in response to user interactions through, e.g. a physical button 404, or a soft button 403 on an on-screen GUI 402.

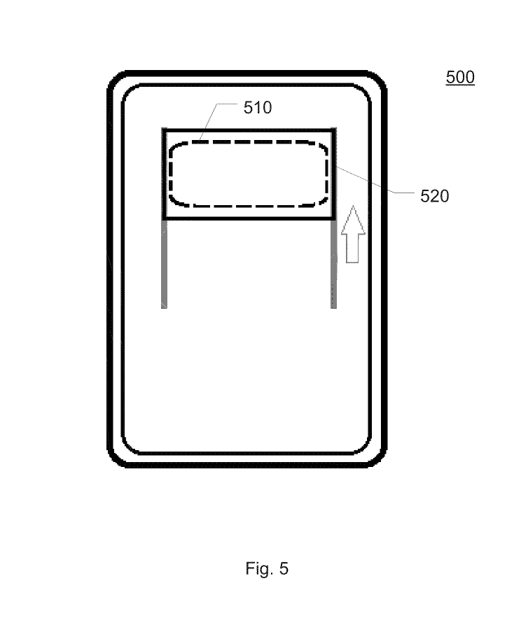

FIG. 5 illustrates a back side of a mobile computing device 500 equipped with a sliding cover 520 for a synthetic setae member 510 in accordance with an embodiment of the present disclosure. A user can move the sliding cover 520 to hide the setae member 510 from the ambient environment when the adhesive 510 is not in use.

The method of using synthetic setae as reusable adhesive can be employed in association with any type of mobile computing device in accordance with the present disclosure. For example, the mobile computing device can be smart phones, laptops, personal digital assistances, media players, touch pads, or alike.

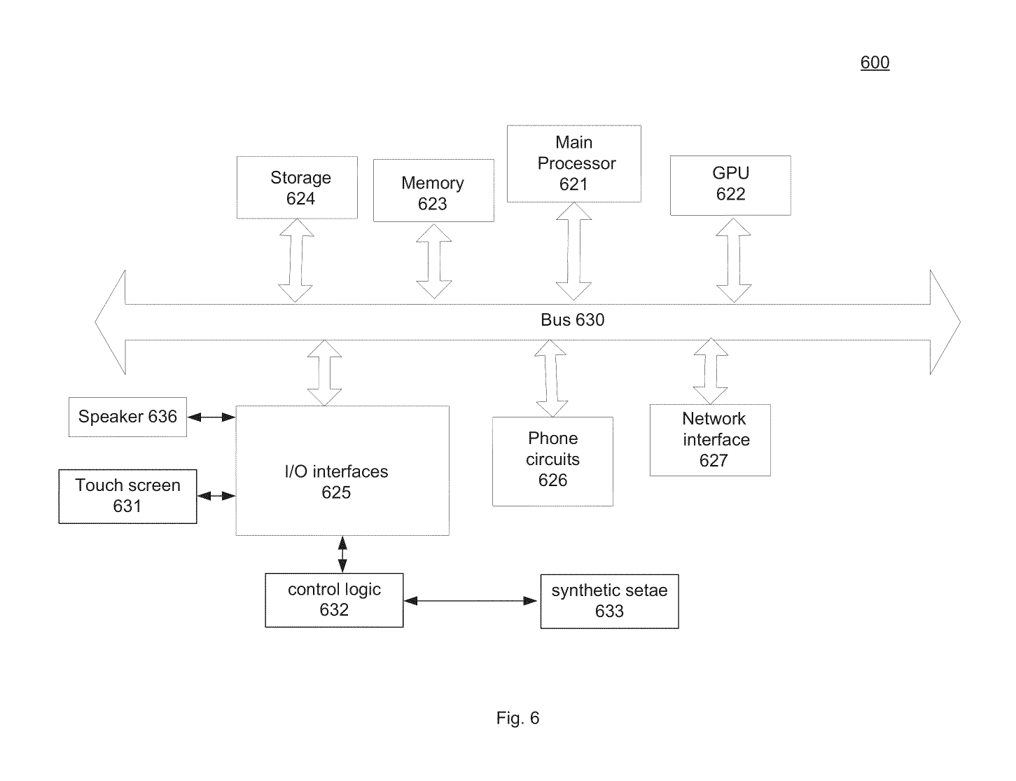

FIG. 6 is a block diagram illustrating an exemplary configuration of a mobile computing device 600 employing synthetic setae 632 as reusable adhesive in accordance with an embodiment of the present disclosure. In some embodiments, the mobile computing device 600 can provide computing, communication as well as media playback capability. The mobile computing device 600 can also include other components (not explicitly shown) to provide various enhanced capabilities.

According to the illustrated embodiment in FIG. 6, the mobile computing system 600 comprises a main processor 621, a memory 623, an Graphic Processing Unit (GPU) 622 for processing graphic data, an Audio Processing Unit (APU) 628 for processing audio data, network interface 634, a storage device 624, a Global Positioning System (GPS) 629, phone circuits 626, I/O interfaces 625, and a bus 620, for instance. The I/O interface 625 comprises a speaker I/O interface 631, a touch screen I/O interface 632, and an interface coupled with control logic 632 used to control the synthetic setae 633.

The main processor 621 can be implemented as one or more integrated circuits and can control the operation of mobile computing device 600. In some embodiments, the main processor 621 can execute a variety of operating systems and software programs and can maintain multiple concurrently executing programs or processes. The storage device 624 can store user data and application programs to be executed by main processor 621, such as the live audio effect GUI programs, video game programs, personal information data, media play back programs. The storage device 624 can be implemented using disk, flash memory, or any other non-volatile storage medium.

Network or communication interface 634 can provide voice and/or data communication capability for mobile computing devices. In some embodiments, network interface can include radio frequency (RF) transceiver components for accessing wireless voice and/or data networks or other mobile communication technologies, GPS receiver components, or combination thereof. In some embodiments, network interface 634 can provide wired network connectivity instead of or in addition to a wireless interface. Network interface 634 can be implemented using a combination of hardware, e.g. antennas, modulators/demodulators, encoders/decoders, and other analog/digital signal processing circuits, and software components.

I/O interfaces 625 can provide communication and control between the mobile computing device 600 and a touch screen panel and other external I/O devices (not shown), e.g. a computer, an external speaker dock or media playback station, a digital camera, a separate display device, a card reader, a disc drive, in-car entertainment system, a storage device, user input devices or the like. The processor 621 can then execute pertinent GUI instructions, such as the live audio effect GUI as in FIG. 6, stored in the memory 623 in accordance with the converted location signals.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A mobile computing device comprising:
a processor coupled to a memory and a bus;
a display panel coupled to said bus;
an exterior housing comprising a synthetic setae member array, said array operable to selectively secure said exterior housing to an extrinsic surface by adhesive force, wherein said exterior housing is configured to contain said processor, said memory, and said bus and secure said display panel.

2. The mobile computing device of claim 1, wherein said synthetic setae member array comprises a plurality of members, each member comprising material selected from a group consisting of: polyimide, polyurethane, polydimethyl siloxane, carbon nanotube (CNT), and a combination thereof.

3. The mobile computing device of claim 1, wherein said synthetic setae member array comprises a flexible substrate and a plurality of pillars having diameters within the range of 0.2 to 10 microns, said pillars extending from said flexible substrate and having a surface density of approximately 500 hairs per square millimeter.

4. The mobile computing device of claim 2, wherein said material is fabricated by processes comprising at least one of photolithography/electron beam lithography, plasma etching, deep reactive ion etching (DRIE), chemical vapor deposition (CVD), and micro-molding.

5. The mobile computing device of claim 1, wherein said exterior housing is operable to be released from said extrinsic surface when a mechanical force is applied to disengage said adhesive force.

6. The mobile computing device of claim 1 further comprising control logic operable to activate or deactivate said adhesive force in response to a user interaction

7. The mobile computing device of claim 2 further comprising a removable cover that, when engaged, is operable to isolate said synthetic setae member array from an ambient environment.

8. The mobile computing device of claim 1, wherein said extrinsic surface is a solid surface area of an object selected from a group consisting of: a door, a wall, a desk, a window, and a cardboard, and wherein further said synthetic setae member is reusable for selectively securing a plurality type of extrinsic surfaces.

9. The mobile computing device of claim 3, wherein said exterior housing comprises an exterior front surface, an exterior back surface opposite to said exterior front surface, and exterior sides, wherein said display panel is disposed in said exterior front surface, and wherein further said synthetic setae member array disposed thereon at said exterior back surface, and wherein said synthetic setae member array is in a substantially rectangular shape.

10. An apparatus operable to adhere a mobile computing device to various external solid surfaces, said apparatus comprising:
a fabricated setae component comprising: a plurality of elongated protrusions and a substrate supporting said plurality of elongated protrusions, wherein said plurality of protrusions are operable to adhere to said various external solid surfaces by intermolecular Van der Waals forces; and
a base component supporting said fabricated setae component, said base component operable to be coupled with a housing of said mobile computing device.

11. The apparatus of claim 10, wherein at least one of said plurality of elongated protrusions is operable to provide an adhesive force at a surface of between about 60 and 2,000 nano-Newtons.

12. The apparatus of claim 10 further comprising additional fabricated setae components arranged in a pattern and supported by said base component, wherein said base component is a detachable accessory to said mobile computing device.

13. The apparatus of claim 10, wherein said various external solid surfaces comprise a glass surface, a wall paint surface, a wooden surface, a metal surface, a tile surface, a brick surface, a concrete surface, a plastic surface, or a combination thereof.

14. The apparatus of claim 11 further comprising a cover member that, when engaged, is operable to enclose said fabricated setae component.

15. A mobile computing device comprising:
a processor coupled to a memory and a bus;
a display panel coupled to said bus;
an exterior housing configured to contain said processor, said memory, said bus and secure said display panel; and
a reusable dry adhesive member coupled to said exterior housing, said reusable dry adhesive member operable to adhere said exterior housing to said various external supporting surfaces, said reusable dry adhesive member comprising:
a plurality of fibriliar protrusions, when engaged, operable to adhere to said various external supporting surfaces via Van der Waals forces; and
a substrate supporting said plurality of fibriliar protrusions.

16. The mobile computing device of claim 15, wherein said plurality of fibriliar protrusions are engaged upon a pressure being applied on said exterior housing against an external supporting surface, and wherein further said plurality of fibriliar protrusions are detachable from said external supporting surface without damaging said external supporting surface.

17. The mobile computing device of claim 15 wherein said plurality of fibriliar protrusions comprise cyclodextrins, crown ethers, polyhedral ligometric silsequioxanes, o combinations thereof, and wherein said plurality of fibriliar protrusions are capable of self-cleaning.

18. The mobile computing device of claim 15 further comprising: control circuitry coupled to said dry adhesive member; and a graphic user interface configured to instruct said control circuitry to selectively activate or deactivate said reusable dry adhesive member in response to a user request.

19. The mobile computing device of claim 15, wherein said reusable dry adhesive member is operable to adhere said exterior housing to an external surface against a total gravity of said mobile computing device.

20. The mobile computing device of claim 15, wherein said exterior housing comprises a slide cover operable to cover said reusable dry adhesive member to isolate said reusable dry adhesive member from said various external supporting surfaces.
